(19) United States
(12) Patent Application Publication
(10) Pub. No.: US 2016/0034701 A1
(43) Pub. Date: Feb. 4, 2016

(54) MONETIZING PRODUCT FEATURES AS PART OF ENFORCING LICENSE TERMS

(71) Applicant: MICROSOFT TECHNOLOGY LICENSING, LLC, REDMOND, WA (US)

(72) Inventors: Jose Alberto Lozano Hinojosa, Seattle, WA (US); Ozan Ozhan, Kirkland, WA (US); Linden D. Goffar, Snohomish, WA (US)

(73) Assignee: MICROSOFT TECHNOLOGY LICENSING, LLC, REDMOND, WA (US)

(21) Appl. No.: 14/883,707

(22) Filed: Oct. 15, 2015

Related U.S. Application Data
(62) Division of application No. 12/962,897, filed on Dec. 8, 2010.

(51) Int. Cl. G06F 21/62; G06F 9/54; G06Q 20/12; G06F 17/30

(52) U.S. Cl. CPC G06F 21/6218; G06F 17/30917; G06F 9/542; G06Q 20/1235; G06F 2221/2141

(57) ABSTRACT

Control access features include the use of a number of validation rules and capabilities of a target as part of proving license control and revenue generating functionalities, but the embodiments are not so limited. An exemplary role-based computing architecture includes the use of feature to command mappings and one or more validation rules to determine if a target of a command has a proper set of capabilities as part of allowing the command to execute. A computing method of one embodiment operates to provide a validation mechanism that performs a validation evaluation as part of a scope check to ensure that a target command is within the command issuer's scope along with a validation rule check for a particular service feature.

### RELATED APPLICATIONS

This application is a divisional of U.S. application Ser. No. 12/962,897, filed Dec. 8, 2010, entitled Monetizing Product Features as Part of Enforcing License Terms, the disclosure of which is hereby incorporated by reference in its entirety.

### BACKGROUND

Managing complex online services, including enterprise services, can be a daunting task. For example, a typical enterprise system includes different levels of access based in part on a type of user (e.g., administrators, tenant administrators, end-users, etc.). Assigning access and use permissions for various resources (e.g., files and file systems, email items and systems, directory objects, etc.) is challenging since an assignment depends on what a user needs for a business function, as well as implementation details of any business functions in order to perform desired actions. Licensing enforcement adds an additional layer of complexity due in part to the types of license terms that need to be enforced according to an underlying license or feature, especially as implementation details and arrangements tend to be fluid.

Complex messaging systems can also include system administration, service administration, tenant administration, and self-service administration aspects. System administration may involve deploying and maintaining servers, system configuration tasks, provisioning and maintenance of recipients, etc. Management service administration may involve management actions to run multi-tenant hosted services such as the creation and maintenance of hosted organizations, and interactions with partner services and service upgrades. Tenant administration may involve management actions that hosted organization administrators can perform, such as changing settings of the hosted organization, adding or removing recipients, etc. Self-service administration involves management actions that may be delegated to a user, such as changing a name or address and, creation and maintenance of distribution lists and email subscriptions. However, issues can arise due in part to different approaches to managing the complex service environment, including managing inconsistent policies and security process, duplicity of resources, and an unintended release of or access to restricted information, services, and/or resources as examples.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide control access features, including using a number of validation rules and capabilities of a target as part of proving license control and revenue generating functionalities, but the embodiments are not so limited. In an embodiment, a role-based computing architecture includes the use of feature to command mappings and one or more validation rules to determine if a target of a command has a proper set of capabilities as part of allowing the command to execute. A computing method of one embodiment operates to provide a validation mechanism that performs a validation evaluation as part of a scope check to ensure that a target command is within the command issuer's scope along with a validation rule check for a particular service feature. Other embodiments are included.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing architecture.

FIG. 2 is a flow diagram illustrating an exemplary process of providing control access features.

FIG. 3 depicts an exemplary class diagram and an associated license enforcement model.

FIG. 4 is a flow diagram illustrating an exemplary process of providing control access features.

FIG. 5 is a block diagram illustrating an exemplary computing environment for implementation of various embodiments described herein.

### DETAILED DESCRIPTION

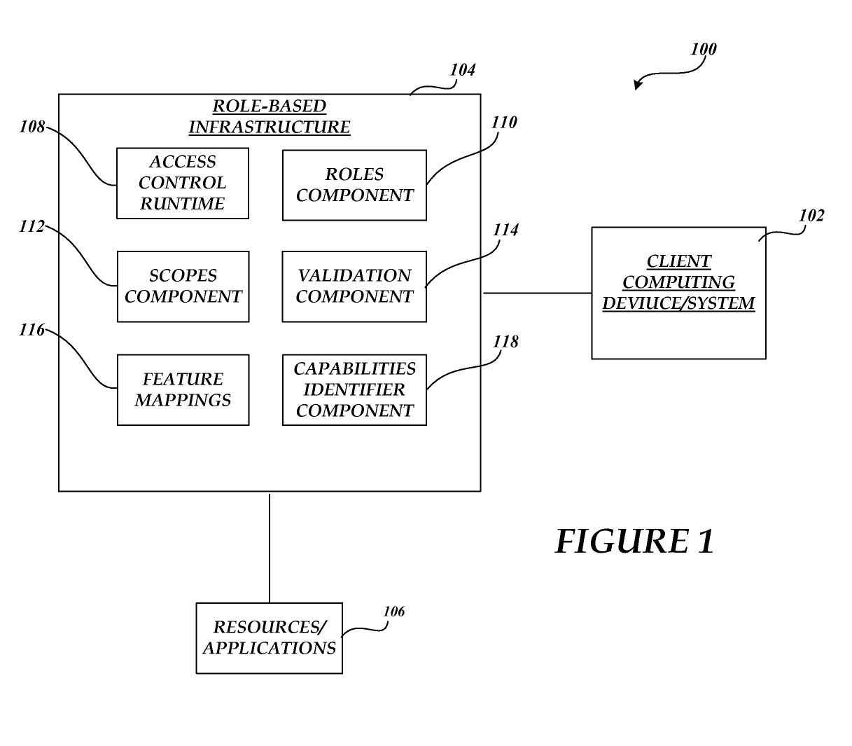

FIG. 1 is a block diagram of an exemplary computing architecture 100 that includes processing, memory, and other components that provide role-based control and other features. Components of the architecture 100 can be used as part of license control and monetization operations. In an embodiment, components of the architecture 100 operate to define and/or use permissions according to constraints, conditions, and/or terms of a license based in part on defined business logic for an associated assignee. As described below, components of the architecture 100 use a number of roles, scopes, capabilities, restricted capabilities, and/or associated validation rules as part of controlling and monetizing aspects of licensable features of an application service infrastructure. For example, components can be used to provide a hosted application and resource provisioning environment by controlling functionalities according to a type of license or feature.

In one embodiment, a role-based access control (RBAC) process includes a validation rule check, running in parallel, before, or subsequent to a scope check, including, but not limited to, identifying actions or commands associated with one or more defined features as part of processing a command input and using a feature set to identify capabilities and/or restricted capabilities. For example, components of an RBAC infrastructure can utilize a directory service to examine target objects of a command for a set of capabilities and/or restricted capabilities as part of enforcing one or more license terms.

As part of such an embodiment, an RBAC process includes a validation rule check, running in parallel, before, or subsequent to a scope check, including identifying any validation rule or rule sets associated with a defined feature. For example, a global mailbox feature uses management permissions and associated commands as part of examining capability sets of role-based target objects to determine whether one or more validation rules are applicable to the feature use attempt, and either allowing execution of the action or providing a notice/informative communication. In one embodiment, if the rule does apply to the target's set of restricted capabilities, an error communication protocol can provide an error message to a user attempting to use the feature for display. For example, an access control runtime component (e.g., RBAC runtime) can use a feature to command mapping database to locate relevant features to be validated using one or more validation rules and/or one or more sets of capabilities and/or restricted capabilities as part of providing license enforcement and monetization features.

As shown in FIG. 1, the architecture 100 includes at least one client 102 in communication with a role-based computing infrastructure 104. The infrastructure 104 isolates resources/applications (shown collectively as 106) from the at least one client 102 and provides a mechanism to validate command inputs, and use one or more validation rules and target capabilities to enforce and monetize license terms, but is not so limited. A role-based model of one embodiment can be used to manage licenses and/or license features as part of managing aspects of a cloud computing environment. The model of one embodiment accounts for target capabilities as part of a licensing and monetization assessment, including the use of one or more validation rules to restrict user actions based in part on recognized features associated with a target capability set.

For example, an RBAC runtime system can use aspects of the model to control action and/or command inputs by packaging and sending error messages to administrators and/or end-users due in part to identified capabilities that can include a number of restricted capabilities associated with a target user or object. The model allows for monetization in the case of licensing certain features that should be restricted regardless of the user, device, and/or application attempting to make a change. For example, customers wanting to differentiate a pricing structure may want to give remote users more capabilities than other users sitting at desks who do not need additional protocols. Such a model provides a mechanism to control price by giving users that need the features greater features, while other users get lesser features for a lower price of as part of subscribing to a service or use of a resource.

As shown, the role-based computing infrastructure 104 includes an RBAC runtime component 108, roles component 110, scopes component 112, validation component 114, feature mappings component 116, and capabilities identifier component 118. As described below, validation rules and identified sets of capabilities can be used in addition to, or simultaneously with, a scope check to ensure that administrator and end-user commands comport to or comply with a license or monetization feature. For example, a scope check can include the use of absolute and relative scopes, wherein absolute scopes are independent of a user and relative scopes relate to at least one of self, groups, distribution groups, reports, etc.

A scope can include a set of objects on which tasks defined in a role can operate. Accordingly, a scope can be used to define allowable actions and/or unallowable actions. In an embodiment, a scope of a derived role cannot exceed the scope of a parent role from which the derived role is generated. A derived role can be scoped to any appropriate actions and action parameters of the parent (e.g., existing) scope from which the derived role is generated. Entry modification (e.g., removal) can be performed to further narrow the scope of the derived role. As described below, in addition to user based rules, such a scope and validation rule model can be applied to any object as long as the object can be marked up with one or more capabilities.

In one embodiment, capabilities can be stored in a dedicated directory server on the user object, such that each user has an identifiable set of capabilities associated with a particular subscription or license type. For example, the RBAC runtime component 108 can use a directory service to determine sets of capabilities for end-users as part of processing command inputs and communicating error messages to an issuing user (administrator, tenant administrator, end-user, etc.) which may result in selection of and payment for an additional service or feature (e.g., prelicense, upgrade, update, etc.).

As shown in FIG. 1, the roles component 110 of one embodiment can be used to define and manage roles, and the scopes component 112 can be used to define and manage scopes and scope types, wherein roles and scopes can be associated with a user or one or more groups of users. Roles and scopes can be assigned to both users and groups. The roles component 110 and scopes component 112 can be used to define and grant roles and scopes to administrators, directly and indirectly. For example, an indirect grant includes addition of an administrator to a group having previously granted a specific scope and role, whereas a direct grant includes directly granting scope and role assignment actions. As an example, a certain type service subscription provides a number of allowable administrator actions as long as a target user is with the administrator's scope of license.

The role-based validation infrastructure can use a common set of primitives that represent actions of end-users, partners, tenants, datacenter administrators, enterprise administrators, and/or other users. The primitives can be represented by commandlets (cmdlets) and API calls, but are not so limited. A role of one embodiment includes role actions and a number of action parameters that define permissions associated with a role. Roles can be assigned in several ways, such as direct assignment, assignment to a security group or other object, and/or assignment to a policy (and then assigned to numerous end-users) as examples. Assignments can be created, retrieved and managed using a common tool set.

In one embodiment, the architecture 100 uses a role and capabilities based layer as part of providing an administration of network services and/or resources. The layer can use the roles component 110 to define roles that represent administrative actions and associated action parameters, and the scopes component 112 to define scopes to be associated with the roles, wherein the scopes define objects on which the administrative actions and action parameters operate. In one embodiment, the scopes component 112 can also define and manage custom scopes, organizational unit (OU) scopes, relative scopes, absolute scopes, filter-based scopes, and/or other types of scopes. For example, validation rules can be based in part on aspects of a scope type.

Roles, scopes, and associated validation rules can be implemented to provide management actions for multi-tenant hosted service administration. The roles, scopes, and validation rules can also control management actions for tenant administration and also for self-service administration operations. In one embodiment, the architecture 100 includes a centrally located storage component for storing roles, scopes, and/or sets of capabilities for administration of user actions. In another embodiment, validation rules and/or command/action to feature mappings can also be stored in central storage or each can include a dedicated server. Other embodiments are available. Exemplary roles can include an enterprise administrator role, enterprise end-user role, tenant administrator role, tenant end-user role, a datacenter administrator role, a partner role, managed role, federated role, cloud access role, etc.

Acting as an additional layer of security, a validation layer including the validation component 114 uses one or more validation rules to ensure that administrator actions associated with an intended target or targets comply with the one or more validation rules even when the scope check is satisfied. As described below, the capabilities identifier component 118 can use a role in part to determine an associated set of capabilities and/or restricted capabilities. The capabilities identifier component 118 of an embodiment can also define and/or redefine capabilities for various users, objects, and/or groups. In one embodiment, an object can be populated with capability information include metadata defining an associated set of capabilities for use by the validation component 114 when applying validation rules as part of allowing or disallowing a command or action associated with some feature or feature set. As described below, feature mappings 118 can include command and/or action to feature mappings for use in implementing a license enforcement process, privacy violation determination, or other role-based control mechanism.

In an embodiment, a set of capabilities can be attached to an object as metadata, wherein the set of capabilities are based on defined features of some application or resource, such as provided by enterprise business service application vendors for example. In one embodiment, capabilities and/or restricted capabilities can be based in part on one or more stock keeping units SKUs to control and/or limit use of certain command, actions, and/or other features. SKUs can be used in part to manage segments of target software features or markets, including enforcement of allowed and/or disallowed features and/or actions. For example, a SKU parameter can be used in part to send an error message to an administrator upon attempting to perform some action within a role-based business productivity application, wherein the action is disallowed for the particular SKU. Each SKU of one embodiment includes a set of capabilities that dictate a unique set of features/limits that a customer can purchase or use. For example, online application services and features can be offered for consumer purchase, wherein all or particular portions of offered services and/or features can be purchased and used in accordance with purchase and/or license agreement or terms.

In one embodiment, a set of capabilities can be used with a number of validation rules in part to define and control access to different levels or portions of service or resource as part of an online service offering. As one example illustrating use of SKUs, mailboxes and other communication features can be provisioned to include only the set of features allowed by an assigned SKU (e.g., cloud, enterprise, local-only, etc.) as dictated by an associated plan assignment. As another example of use of SKUs, mailboxes and file storage features can be provisioned to include only the set of features allowed by an assigned SKU as dictated by an associated privacy assignment.

As another example, SKUs can be used in part to control and or manage inadvertent or intentional administrator change or changes that may violate a users or group of user's license or assigned set of capabilities. A validation process of one embodiment can be used as part of controlling or limiting the number of features to be enforced, including focusing on high value features to provide amounts of revenue, while allowing reasonable controllable aspects and also ensuring that managed controls do not create significant take backs (e.g., user dissatisfaction/unsatisfactory experience) from the administer and on-premise experience. In alternative embodiments, one or more of the components can be further divided or combined. For example, a dedicated server can be implemented to disconnect resources and/or application services such that no direct communication link is provided to any client. In one embodiment, a server and associated resources can be dedicated to implement RBAC components including an RBAC application, runtime services, and/or administration services.

The functionality described herein can be used by or part of a computing system, including provided as part of a hosted system, application, or other resource. In one embodiment, the architecture 100 can be communicatively coupled to a file system, virtual web, network(s), and/or other information sources as part of providing role-based validation features. An exemplary computing system includes suitable programming means for operating in accordance with a method of enforcing license provisions or terms.

Suitable programming means include any means for directing a computer system or device to execute steps of a method, including for example, systems comprised of processing units and arithmetic-logic circuits coupled to computer memory, which systems have the capability of storing in computer memory, which computer memory includes electronic circuits configured to store data and program instructions. An exemplary computer program product is useable with any suitable data processing system. While a certain number and types of components are described above, it will be appreciated that other numbers and/or types and/or configurations can be included according to various embodiments. Accordingly, component functionality can be further divided and/or combined with other component functionalities according to desired implementations.

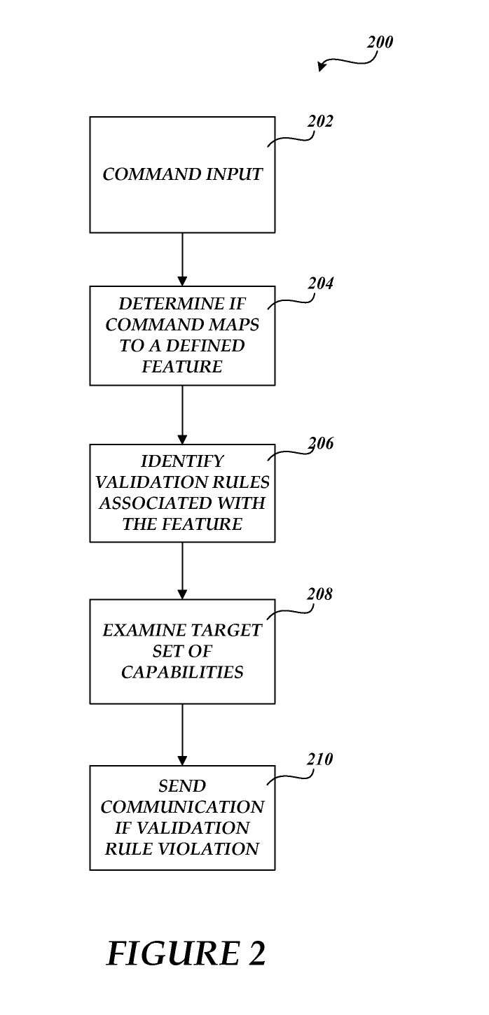

FIG. 2 is a flow diagram illustrating an exemplary process 200 of providing control access features, but is not so limited. In an embodiment, the process 200 includes functionality to control/prevent administrators and/or end-users from performing specific tasks (e.g., EXCHANGE tasks) against a given class of users, also referred to as a user class. A class of users can be defined by any of a number of characteristics such as an assigned or contracted license or a user state, such as a migration state from a hotmail account or LiveID federated as examples. While a certain number and order of operations is described for the exemplary flow of FIG. 2, it will be appreciated that other numbers and/or orders can be used according to desired implementations.

The process 200 of an embodiment can be used as part of a hosted space/computing environment as part of focusing on areas of monetization of an offered service, including the requisite enforcement of licenses and associated terms and/or conditions. For example, an application and computing platform can be used to provide features of an online business productivity suite/computing architecture that is offered to customers through some number of varying subscription types as part of providing role-based access control and/or other control features.

In one embodiment, the process 200 uses RBAC features including use of a number of validation rules in conjunction with one or more identifying features as part of controlling and monetizing aspects of an offered service. An RBAC system provides role-based scoping and validation mechanisms as part of providing a robust security and compliance strategy to protect critical business resources including digital assets, computing and network resources, databases, online service offerings, data center frameworks, etc. For example, a RBAC system runtime uses the process 200 and one or more SKUs to control access to various subscribed to and licensed features. Each SKU of one embodiment includes a set of capabilities that dictate a unique set of features/limits that a customer can purchase or use. For example, online application services and features can be offered for consumer purchase, wherein all or particular portions of offered services and/or features can be purchased and used in accordance with a purchase and/or license agreement or terms.

In one embodiment, a set of capabilities can be used in part to define and control access to different levels or portions of an online service that a customer can purchase and use as part of an online service offering. In one embodiment, at provisioning time, mailboxes and/or access permissions can be configured with only the set of features allowed by an assigned SKU, dictated in part by a mailbox plan assignment for example. The process 200 can operate to control and or manage inadvertent or intentional administrator changes that may violate a users or group of user's license or assigned set of capabilities. The process 200 of one embodiment can be used as part of controlling or limiting the number of features to be enforced, including focusing on high value features that can be reasonably controlled while ensuring that the managed controls do not create significant limitations or drawbacks from the administer and on-premise experience.

For example, the process 200 can include various RBAC features, as shown by the examples in Table 1 below.

TABLE 1

| Control aspect | Features | Justification |
|---|---|---|
| Ensuring | Unified Messaging | Enterprise SKU |
| administrators do | | differentiator |
| not violate a license | Archive Mailboxes | Enterprise SKU |
| by modifying a | | differentiator, and add |
| mailbox property | | on opportunity |
| | POP/IMAP client access | Standard SKU |
| | | differentiator |
| | MAPI (rich client) access | Standard SKU |
| | | differentiator |
| | EWS (Entourage) access | Standard SKU |
| | | differentiator |
| Ensuring | Legal Hold | Enterprise SKU |
| administrators do | | differentiator |
| not violate a license | | |
| through using a | | |
| Global | | |
| Cmdlet Based | | |
| Features | | |
| Ensuring | Supports proper control | |
| administrators do | panel segmentation of | |
| not violate a license | features | |
| through a Role | | |
| Assignment | | |
| Ensuring | Application/thread/process | Standard SKU |
| administrators do | throttling (Segmentation) | differentiator |
| not violate a license | email web application | |
| by modifying or | | |
| assigning an | | |
| inappropriate Policy | | |

With continuing reference to FIG. 2, as part of providing RBAC license enforcement and monetization features, the process 200 at 202 receives a command input. For example, an RBAC runtime system can process administrator and/or end-user commands and/or actions (e.g., received from a command executor or issuer) as part of controlling and monetizing aspects of an online application service offering or feature. As an example, the process 200 at 202 can use received and/or requested control inputs (e.g., one or more dedicated servers can be used intercept command and other communications) associated with an action that violates one or more validation rules, such as rules to control various command interception and examination operations, as shown in part by the examples of the Table above.

As shown by the examples above, validation rules can be used, but are not so limited, to: ensure that administrators do not violate a license by modifying a mailbox or other specified property; ensure that administrators do not violate a license using Global Cmdlet Based Features; ensure that administrators do not violate a license through a Role Assignment; and/or ensure that administrators do not violate a license by modifying or assigning an inappropriate Policy. For example, an RBAC service can be used to expose functions as part of creating and managing roles, resources, permissions, validation rules, user role assignments, resource permission assignments, and/or associated RBAC policies.

At 204, the process 200 operates to determine whether administrator and/or role-based user command inputs map to a defined feature(s) or action(s) based in part on one or more feature to command mappings. In one embodiment, the process 200 at 204 uses an RBAC runtime system and a mapping database to process administrator command inputs as part of determining whether the command input violates a license term or aspect while enabling administrators to fully manage a “Managed” user base and being prevented from changing any on-premise mastered properties of a “Federated” user base. Exemplary properties include, but are not limited to:

NewUserPasswordManagementPermissions;

NonFederatedModeratedRecipientsPermissions;

NonFederatedRecipientManagementPermissions;

ProfileUpdatePermissions; and/or

ResetUserPasswordManagementPermissions.

At 206, the process 200 operates to identify whether one or more validation rules are associated with the determined feature or action. For example, the process 200 at 206 uses the RBAC runtime system and a validation rules component as part of identifying the one or more validation rules to be applied for the particular feature or action. At 208, the process 200 operates to examine a set of capabilities associated with each target (e.g., user object, capability object, etc.) user as part of determining whether to allow the command input. For example, the process 200 at 208 can use the RBAC system and a directory component (e.g., ACTIVE DIRECTORY system) to identify one or more sets of capabilities of users targeted by the command according to a role type.

In one embodiment, each set of capabilities can be determined or assigned based in part on a type of license, agreement, assignment and/or term(s) of a use contract as examples. For example, mailboxes and/or other resources can be configured at provisioning time with only the set of features/capabilities allowed by an associated SKU as dictated by an associated Mailbox Plan assignment. At 210, the process 200 operates to send a communication (e.g., error message) to the command initiator and/or target(s) if there is a validation rule violation for the associated set of capabilities. In one embodiment, the process 200 at 210 also operates to communicate a message and/or process the command if an associated set of capabilities conforms or complies with one or more validation rules. For example, the RBAC runtime system can issue a message associated with a validation rule violation or process the command or request based on whether an associated validation rule evaluates to true or false (e.g., LICENSE VIOLATION: You may not perform the <Action> on <User> with assigned license <Capability ID>).

The process 200 of an embodiment controls management of a population that spans multiple plans/capability sets, which includes using granted management rights over a superset of features that may be granted to any of the associated users. The process 200 can be used in part to work with a paid service based on the features offered within a given level as part of preventing administrators from violating terms of a license agreement, regardless of intent. The process 200 of one embodiment defines and/or uses permissions according to constraints, conditions, and/or terms of a license using business logic defined in part by assignees of the business logic, using roles, scopes, a set of capabilities, a set of restricted capabilities, and/or a number of associated validation rules. For example, the process 200 can be used to prevent tenant administrators from performing specific actions on specific users or objects.

The process 200 can be used to enable license enforcement and monetization of segmented features that include absolute administrator oversight and management, whereas other features can simply be tenant admin immutable, wherein the validation rules that are used to prevent a license violation are administrator immutable. As one example, the process 200 can operate to send a message for an unauthorized action or command as a result of application of an associated validation rule that includes an informative reason that makes the violation clear to the Administrator or user. In other embodiments, the process 200 that operates to prevent license violations is consumable by various user interfaces and/or applications to segment out features based on one or more validation rules. Other embodiments are available.

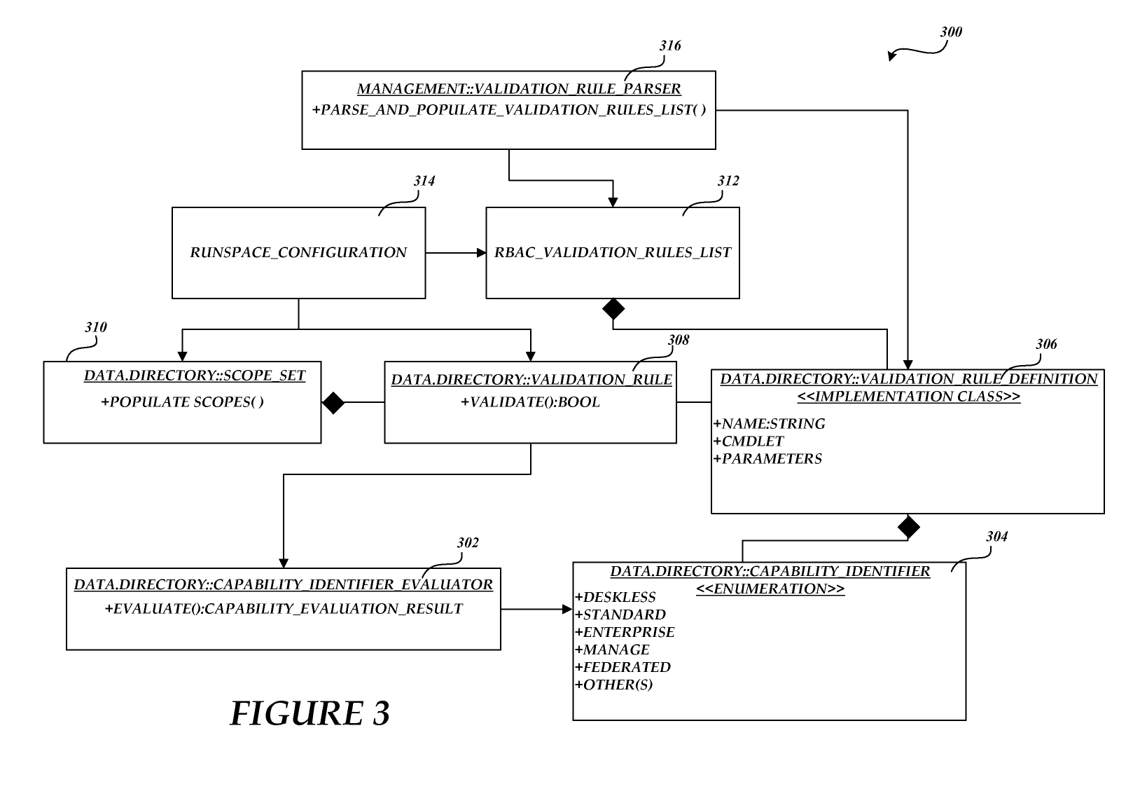

FIG. 3 depicts an exemplary class diagram 300 and an associated license enforcement model used as part of implementing a mechanism for enforcing and/or monetizing license or other features using a role-based computing architecture. In one embodiment, the model can be implemented as part of extending an RBAC infrastructure allowing for definition and runtime evaluation of business rules as part of an authorization and scope validation process based in part on a number of validation rules and/or at least one set of target capabilities. As described below, the model of one embodiment accounts for target capabilities as part of a licensing and monetization evaluation, including using one or more validation rules to restrict user actions based in part on recognized features associated with some capability set.

For example, an RBAC runtime system can use aspects of the model to control action and/or command inputs by packaging and sending error messages to administrators and/or end-users due in part to identified capabilities that can include a number of restricted capabilities associated with a target user or object. The model allows monetization in the case of licensing as certain features should be restricted regardless of the user attempting to make a change. In addition to user based rules, such a model can be applied to any object as long as the object can be marked up with a set of capabilities.

Such a model and associated components allow for separation of business logic, such as license enforcement from concepts, such as Roles, Scopes and Role Assignments for example, by using a capability-driven validation mechanism when processing command inputs. In one embodiment, a RBAC runtime component (see FIG. 1 for example) assumes an additional role of arbitrator for business logic driven validation along side of or in parallel with the authorization process. As an example of operation of the validation mechanism, when an administrator performs a task or action that they have already been granted rights to perform using an RBAC infrastructure, an RBAC runtime then operates to perform a second level of evaluation, including a scope check to ensure that the target of the action is within the administrators scope along with validation rule check.

In one embodiment, such a validation rule check includes, but is not limited to: identifying if an action or command is associated with a defined feature (e.g. Set-CASMailbox −ImapEnabled $True is associated with the IMAPPermissions feature); identifying any validation rule or rules associated with such a defined feature, including retrieving or identifying a set of restricted capabilities (e.g. The feature ImapEnabled is restricted from users with a set of capabilities that includes Deskless user); examining target user(s)/object(s) set of capabilities and/or restricted capabilities to determine whether the rule applies; and allowing execution of the action if the rule does not apply to the target's set of restricted capabilities, or providing/displaying an error message if the rule applies to the target's set of restricted capabilities. For example, the RBAC runtime can use a feature to command database to locate relevant features to be validated using the validation rules and one or more sets of capabilities and/or restricted capabilities as part of providing license enforcement and monetization features.

The model of one embodiment uses a new syntax and provides a central location for feature teams to define validation rules for associated features and a given defined population of users, independent of feature code. In one embodiment, a role-based computing infrastructure includes an ability to store or calculate a per-user/object set of capabilities (e.g., a definition of a user population) against which a rule can be evaluated, wherein a given rule can be associated with a context specific error message. Correspondingly, implemented validation rules account for a target user state or set of capabilities, which can be stored directly or calculated based on per-user or global settings. While the model is applicable to license enforcement and monetization aspects, it can also be used in other control type scenarios.

As shown in FIG. 3, the class diagram 300 illustrates an exemplary data model including relationships between objects used as part of a controlling aspects of a computing environment, such as a controlling use of features included in a computer program product or download for example. For example, the data model can be implemented as part of a computerized license violation control and/or enforcement mechanism for a cloud computing environment. In one embodiment, components of a role-based computing architecture provide definition and runtime evaluation of implemented business rules during an authorization and scope validation process. As discussed below, components of a role-based computing architecture of an embodiment allow component teams to easily define particular validation rules based in part on a number of assigned capabilities or features associated with one or more particular service and/or use licenses.

In one embodiment, an RBAC-based computing architecture (e.g., an EXCHANGE server infrastructure) is configured to enable component teams to easily define particular validation rules dependent in part on one or more capabilities or features, wherein business logic based rules can be implemented using an RBAC-based validation mechanism. Using such a model allows enforcement of both administrative actions as well as self-service actions where a user is making a change to an associated user object.

With continuing reference to FIG. 3, the class diagram 300 includes a capability identifier evaluator 302. The capability identifier evaluator 302 can operate to determine if a given capability is present on a given object, outputting an enumerated capability evaluation result (e.g., Yes, No, Not Applicable, etc.). For example, the capability identifier evaluator 302 can process and chase links, check email addresses and accepted domains, etc. The capability identifier evaluator 302 provides an interface that can be used to determine if a capability is present on a given object, such as by, for example:

enum CapabilityEvaluationResult
{

Yes,
No,
NotApplicable

}
public interface CapabilityIdentifierEvaluator
{

public CapabilityEvaluationResult Evaluate(ADObject targetObject);

}

The capability identifier evaluator 302 of one embodiment uses a capability identifier attribute of an object to denote object assigned capabilities or features. A capability identifier of an object can contain multiple capabilities (i.e., based on SKU, license, product offering, etc.) that can be used part of assessing a set of capabilities for a particular user. In an embodiment, the capabilities can be used as part of performing license enforcement operations, wherein the capabilities can be persisted in a directory structure, such as an ACTIVE DIRECTORY data structure for example.

A capability identifier 304 can be defined as enumeration (enum), as shown by the example:

enum CapabilityIdentifier

{

DeskLess,
Standard,
Enterprise,
etc.
}

Exemplary capabilities can be based on and include, but are not limited to, a mailbox SKU (e.g., desk-less, standard, enterprise, etc.), managed, unmanaged, federated, signed time of use (TOU), etc. For example, such capabilities can be read directly using a directory object including capability attributes and/or multi-valued property or properties and values associated with the attributes. Exemplary capabilities can also be based on and include calculated types including filter like definitions, such as large quota, Messaging Application Programming Interface (MAPI) enabled, Internet Message Access Protocol (IMAP), etc.

The Validation Rule Definition 306 holds a definition of a validation rule, containing the information associated with a business rule to enforce on an object, such as ADObjects for example. One example:

[Serializable]

internal class RBACValidationRuleDefinition
{

public RBACValidationRuleDefinition(string cmdlet,

IList<string> parameters,

IList<Capability> restrictedCapabilities,
LocalizedString errorMessage)

{

this.Cmdlet = cmdlet;
this.Parameters = parameters;
this.RestrictedCapabilities = restrictedCapabilities;
this.ValidationErrorString = errorMessage;

}
/// <summary>
/// Applicable cmdlet
/// </summary>
public string Cmdlet { get; private set; }
/// <summary>
/// Applicable parameters
/// </summary>
public IList<string> Parameters { get; private set; }
/// <summary>
/// Validation Error String
/// </summary>
public IList<Capability> RestrictedCapabilities { get; private
set; }
/// <summary>
/// Validation Error String
/// </summary>
public LocalizedString ValidationErrorString { get; private
set; }

}

The validation rule 308 consumes the Validation Rule Definition 306. In one embodiment, the validation rule 308 can be evaluated during a scope check, such as an ADScope check for example. As an example:

[Serializable]

internal class ValidationRule
{

private RBACValidationRuleDefinition definition;
protected ValidationRule( )
{ }
public ValidationRule(

RBACValidationRuleDefinition ruleDefinition,
QueryFilter filter)
: base(null, filter)

{

this.definition = ruleDefinition;

}
/// <summary>
/// Hide Parent Property.
/// </summary>
private new ADObjectId Root { get; set; }
/// <summary>
/// Validation Error String
/// </summary>
public LocalizedString ValidationErrorString {

get { return this.definition.ValidationErrorString; }

}

/// <summary>
/// Determines if the given object satisfies the validation
rule
/// </summary>

public bool Validate(ADObject targetObject)
{

return true;

}

}

The Scope Set 310 of an embodiment is an extended object will be extended to include a list of applicable validation rules (e.g., contains a list of Validation Rules). As an example:

[Serializable]

internal class ScopeSet
{

private ADScope recipientReadScope;

. . .
. . .

private IList<ValidationRule> validationRules;
public ScopeSet(

ADScope recipientReadScope,

. . .
. . .

IList<ValidationRule> validationRules)

{

this.recipientReadScope = recipientReadScope ??
ADScope.Empty;

. . .

this.validationRules = validationRules??

new List<ValidationRule>(0);

}

. . .
. . .

public ADScope RecipientReadScope
{

get { return this.recipientReadScope; }

}

. . .
. . .

public IList<ValidationRule> ValidationRules
{

get { return this.validationRules; }

}

}

For example, an AD Driver API can be overloaded to allow specifying a list of validation rules to apply on a given object (e.g., call Validate on all the Validation Rules). RBAC validation rules list 312 contains a list of all validation rules definitions available and provides an API to add/remove/search for rule definitions. In one embodiment, a singleton pattern is used having one instance per process. As an example:

[Serializable]

internal class RBACValidationRulesList :

Collection<RBACValidationRuleDefinition>

{

private static RBACValidationRulesContainer validationRulesDefinition =

null;

public static RBACValidationRulesContainer Instance
{

get
{

if (null == validationRulesDefinition)
{

RBACValidationRulesList ruleDefinition =

new RBACValidationRulesList ( );

Interlocked.CompareExchange<RBACValidationRulesList>(ref

validationRulesDefinition, ruleDefinition, null);

}
return validationRulesDefinition;

}

}
private RBACValidationRulesContainer( )

: base( )

{ }
public IList<RBACValidationRuleDefinition> GetValidationRules(

string cmdlet,
List<string> parameters)

{

...
...
return ...;

}

}

The Runspace Configuration 314 is configured to populate the Scope Set 310 with a set of applicable rules. For example, the Runspace Configuration 314 can operate to populate the Scope Set 310 with a set of applicable rules for a given cmdlet/parameter only if the executing user is a Tenant User type, querying a single global instance of RBAC Validation Container for the information.

The Validation Rules parser 316 operates to validate that for every rule definition the given feature definition exists and perform an example correlation: Rule Definition to Feature Definition to Cmdlet/Parameter including using cmdlet configuration entries. The parsing, validation, and population of validation rules can be performed as:

1. Parse during compile time, validate the XML, correlate Rules Definition to Feature to Cmdlet, and generate the appropriate code (e.g., C#) to populate the RBAC Validation Rules List 312; or,

2. Parse at runtime and during compile time only validate the XML for sanity check. At runtime, parse and perform the exemplary correlation Rules Definition to Feature to Cmdlet. In one embodiment, regardless of the parsing method, the rules can be populated by using ‘Cmdlet Configuration Entries’ to call an object responsible for populating the RBAC Validation Rules List 312.

Validation Rules Definitions of one embodiment are tied to service plan features, enabling component teams to define service plan features and specify a validation rule applicable to each feature. As an example,

public static readonly FeatureDefinition ResetUserPasswordManagementPermissions=

new FeatureDefinition(“ResetUserPasswordManagementPermissions”,
typeof(bool),
FeatureCategory.MailboxPlanPermissions);

Exemplary definitions are shown in Table 2 below:

TABLE 2

| | | | My | |
|---|---|---|---|---|
| Cmdlet | Parameter | | Base | Mail |
| Name | Name | Feature List | Options | Recipients |
| Set- | Password | ResetUserPasswordManagementPermissions | All | All |
| Mailbox | | | | |
| New- | Password | ResetUserPasswordManagementPermissions | All | All |
| Mailbox | | | | |
| Set- | Pop | PopPermissions | All | All |
| CasMailbox | Enabled | | | |

Moreover, for this example:

An exemplary Rule Definition can be defined as follows:

<ValidationRule

Feature=“ResetUserPasswordManagementPermissions”
RestrictedCapabilities=“Federated”
ErrorString=“ManagedFederatedError” />

And, an exemplary Validation Rule Definition can be defined as follows:

newRBACValidationRuleDefinition(“Set-Mailbox”,

new List<string>( )
{

“Password”

},
new List<Capability>( )
{

Capability.Federated

},
ManagedFederatedError),

And,

new RBACValidationRuleDefinition(“New-Mailbox”,

new List<string>( )
{

“Password”

},
new List<Capability>( )
{

Capability.Federated

},
ManagementFederatedError),

And, for this example, a Runtime Applicable ADScope filter example:

{ CapabilityId -ne ‘Federated’ }

When a ‘cmdlet’ scope verification is done on a given object and no ‘parameter’ is specified, validation rules may not be enforced. In one embodiment, a change is made to the cmdlet scope check on a target object to account for such a scenario as shown by the following example processing flow. If parameters are specified, then apply the validation rules applicable to the specified parameters. If no parameters are specified, then get the list of all parameters that the current executing user has access to and for every parameter get all the applicable validation rules, then if all rules are satisfied for the given object, the parameter stays. Otherwise, if at least one rule fails for the given object, then remove the parameter. Then, check the list of parameters. If the list of parameters is empty, then cmdlet Scope verification for the given object failed and the current executing user is not able to execute the given cmdlet on the object, since regardless of the parameters used, all of them violate a license on the target user. If the list is not empty, then cmdlet Scope verification for the given object succeeds and the user is able to execute the cmdlet with at least one parameter on the given object without breaking any rule.

As part of a preemptive validation rules evaluation, a validation rules evaluation algorithm used for cmdlet Scope verification on object can also be applied during initialization to remove all end-user role entries that may lead to a licensing violation for the current executing user, assuming users that do not have any role assignment that grants the same cmdlet through an end-user role and admin role. The model of one embodiment enables an ability to easily define validation rules as metadata as part of introducing and managing validation rules lifecycles, including using validation rules required to meet licensing, legal, and/or technical product requirements. Validation rules can also be defined and stored. In one embodiment, exemplary validation features allow mail administrators to define policies which take into account real-time availability and performance of servers. Due in part to different licensing or legal requirements, validation rules can be implemented such that a given rule or rules may only be applied where applicable.

Validation rule lifecycle management operations can include, but are not limited to: adding a new rule to a validation group, wherein a rule can be applied to all actions across all servers upon deployment; disabling a rule within a validation group including persisting rules in metadata but not to be applied at runtime; and/or removing a rule from a validation group, including removing a rule from the metadata and not applying the removed rule to any runtime actions. Validation rules can apply to both to end-user and administrator actions. For example, a validation rule such as the Managed/Federated requirement that users who are Federated may neither have their password reset nor be able to reset their own password, should apply regardless of whether an Admin or the end-user themselves try to run the “Set-User—Password” task.

Validation rules can also be defined on a per task/parameter basis to restrict only a given parameter of a task. For example “Set-Mailbox—PopEnabled” from being run against a population of Deskless users. Capabilities can be grouped along with localizable error messages specific to each group as part of grouping similar, dependent, and/or related capabilities into groups. For example, a licensing group can be created that identifies all of the licensing specific capabilities as well as a set of licensing specific error messages.

In one embodiment, a discoverability process includes an ability to report on user and capability restrictions so administrators are provided with a tool to identify which features are restricted from a user or group based on RBAC based validation rules that enable, but are not so limited: an administrator to readily identify features that are restricted from a given user or object and also identify which features are restricted from users with a given capability or set of capabilities.

Table 3 lists exemplary Capabilities and Error Strings to meet BPOS standard license enforcement requirements.

TABLE 3

| Capabilities | Error Strings |
|---|---|
| BPOS_S_Deskless | BPOS_S_Property_License_Violation: |
| BPOS_S_Standard | License validation error: the action <Cmdlet>, |
| BPOS_S_Enterprise | <Parameter>, may not be performed on the user |
| | <UserName> with license <Capability> |
| | BPOS_S_Policy_License_Violation: |
| | License validation error: the property |
| | <Parameter> may not be set o policy |
| | <PolicyName> associated with |
| | license <Capability> |

Table 4 lists exemplary validation rules for such capabilities for these examples include, but are not limited to:

TABLE 4

| Rule | Example reason |
|---|---|
| <ValidationRule Feature=“UMPermissions” | |
| RestrictedCapabilities=“BPOS_S_Deskless, | |
| BPOS_S_Standard, BPOS_S_Standard_Archive, | |
| BPOS_S_Archive” | |
| ErrorString=“ BPOS_S_Property_License_Violation” | |
| /> | |
| <ValidationRule Feature=“PopPermissions” | PopPermissions feature is too |
| RestrictedCapabilities=“BPOS_S_Deskless” | inclusive. |
| ErrorString=“ BPOS_S_Property_License_Violation | |
| ”/> | |
| <ValidationRule Feature=“IMAPPermissions” | IMAPPermissons is too inclusive. |
| RestrictedCapabilities=“BPOS_S_Deskless” | |
| ErrorString=“ BPOS_S_Property_License_Violation | |
| ”/> | |
| <ValidationRule | OutlookAnywherePermissions |
| Feature=“OutlookAnywherePermissions” | should be removed from Set- |
| RestrictedCapabilities=“BPOS_S_Deskless” | CASMailbox -Identity |
| ErrorString=“ BPOS_S_Property_License_Violation | |
| ”/> | |
| <ValidationRule Feature=“<LegalHoldPermissions>” | Set-Mailbox -LegalHoldEnabled: |
| RestrictedCapabilities=“BPOS_S_Deskless, | |
| BPOS_S_Standard, BPOS_S_Standard_Archive, | |
| BPOS_S_Archive” | |
| ErrorString=“ BPOS_S_Property_License_Violation | |
| ”/> | |
| <ValidationRule | |
| Feature=“<InboxRuleCreationPermissions>” | |
| RestrictedCapabilities=“BPOS_S_Deskless” | |
| ErrorString=“ BPOS_S_Property_License_Violation | |
| ”/> | |
| Work with OWA team on IM Integration and RSS | |
| Feeds rules. | |
| <ValidationRule Feature=“SMSPermissions>” | |
| RestrictedCapabilities=“BPOS_S_Deskless” | |
| ErrorString=“ BPOS_S_Property_License_Violation | |
| ”/> | |
| <ValidationRule Feature=“ActiveSyncPermissions>” | ActiveSyncPermissions is too |
| RestrictedCapabilities=“BPOS_S_Deskless” | inclusive |
| ErrorString=“ BPOS_S_Property_License_Violation | |
| ”/> | |

Table 5 lists exemplary Capabilities and Error Strings required to meet BPOS standad license enforcement requirements.

TABLE 5

| Capabilities | Error Strings |
|---|---|
| TOU_Unsigned | TOU_Unsigned_Violation: |
| | The action <Cmdlet>, <Parameter>, may not be |
| | performed on the user <UserName> who has not |
| | yet signed a Terms of Use agreement. |

Table 6 lists a number of exemplary validation rules that can be used as part of a migration operation.

TABLE 6
Rule

<ValidationRule
Feature=“ActiveSyncDeviceDataAccessPermissions”
RestrictedCapabilities=“TOU_Unsigned”
ErrorString=“TOU_Unsigned_Violation” />
<ValidationRule
Feature=“MessageTrackingPermissions”
RestrictedCapabilities=“TOU_Unsigned”
ErrorString=“TOU_Unsigned_Violation” />
<ValidationRule
Feature=“SearchMessagePermissions”
RestrictedCapabilities=“TOU_Unsigned”
ErrorString=“TOU_Unsigned_Violation” />
<ValidationRule
Feature=“UserMailboxAccessPermissions”
RestrictedCapabilities=“TOU_Unsigned”
ErrorString=“TOU_Unsigned_Violation” />\

Table 7 lists exemplary Federated User Enforcement Capabilities and Error Strings to meet BPOS standard license enforcement requirements.

TABLE 7

| Capabilities | Error Strings |
|---|---|
| FederatedUser | FederatedUser_Violation: |
| | The action <Cmdlet>, <Parameter>, may not be |
| | performed on the Federated user <UserName>. |

Table 8 lists a number of exemplary validation rules to manage a federated user operation.

TABLE 8
Rule

<ValidationRule
Feature=“NewUserPasswordManagementPermissions”
RestrictedCapabilities=“FederatedUser”
ErrorString=“FederatedUser_Violation” />
<ValidationRule Feature=“ProfileUpdatePermissions”
RestrictedCapabilities=“FederatedUser”
ErrorString=“FederatedUser_Violation” />
<ValidationRule
Feature=“ResetUserPasswordManagementPermissions”
RestrictedCapabilities=“FederatedUser”
ErrorString=“FederatedUser_Violation” />

Some examples illustrate use of the validation mechanism in the enterprise context as part of ensuring that administrators do not violate a license by modifying some licensable user feature, such as a mailbox property for example, while at the same time providing moderated control over some user features (e.g., IMAP, MAPI, POP, ActiveSync, etc.) and preventing entering some operational state that violates some term or terms of an assigned license. For example, the validation features can be used in part to wherein the roles and scopes provide management actions for tenant service administration, multi-tenant hosted service administration, enterprise administration, partner service administration, and datacenter service administration.

### Example 1

Consider a scenario where an organization has purchased subscriptions to a Deskless SKU, a Standard SKU, and an Enterprise SKU defined by the examples in Table 9. In one embodiment, the validation rules track subscription types as part of enforcing license terms.

TABLE 9

| Feature | DeskLess | Standard | Enterprise |
|---|---|---|---|
| IMAPEnabled | False | True | True |
| MAPIEnabled | False | True | True |
| ActiveSynchEnabled | False | True | True |
| UMEnabled | False | False | True |
| Mailbox Quota | 10 GB | 20 GB | 25 GB |

Since an administrator may at any time have users that are assigned the Enterprise SKU it follows that they would need the ability to manage Enterprise Features such as enabling/disabling IMAP for individual users. However by simply giving an Administrator such a right may allow for enabling IMAP for users assigned the DeskLess SKU which could be in violation of an assigned license. Thus, a subscription may come with a bundle of administrator rights, which may violate terms of the assigned license when implemented on certain target users (e.g., DeskLess) or objects.

### Example 2

Illustrates ensuring that administrators do not violate a license by modifying or assigning an inappropriate Policy. For example, the validation mechanism described above can be used as part assessing one or more levels of indirection for Advanced Mobile Device Policies and Retention Policies as part of monetizing features that administrators are allowed to modify and/or assign.

Assume a simple example SKU model as shown in Table 10.

TABLE 10

| Feature | DeskLess | Standard | Enterprise |
|---|---|---|---|
| Mailbox Quota | 10 GB | 20 GB | 25 GB |
| Retention Policies | Only on | Only on Default | Any Folder |
| | Default Folders | Folders | |
| Advanced Mobile | False | False | True |
| Device Policies | | | |

Retention Policies are effectively a double indirection because it is the type of the Retention Tags that are associated with a Retention Policy that dictate whether a policy applies to a Default Folder or to any folder, such that logic can be used to identify tags associated with a given Retention Policy at association time. Logic can be included to prevent adding a retention tag to a Retention Policy if adding a particular tag would violate the license of any of the currently assigned users using logic to identify all existing retention policy assignments. Policy management can be used in part to ensure that administrators do not set inappropriate (license violating) features on a given policy object including examining a capability set that the policy applies to. Policy assignment can be used to ensure that a user is not assigned a policy that would result in license violation using logic to identify the capabilities of the user as well as the policy object. A policy can be created along with a Mailbox Plan to ensure that the policy is properly tied and/or defaulted to a capability set.

### Example 3

Ensuring administrators do not violate a license through using a “Global” feature as part of monetizing a number of global organizational features, illustrated by the examples in Table 11.

TABLE 11

| Feature | DeskLess | Standard | Enterprise |
|---|---|---|---|
| Automatic rule | False | False | True |
| based | | | |
| protection(RMS | | | |
| Transport Rules)* | | | |
| Read & Write | True | True | True |
| Protected Email* | | | |
| Journaling* | False | False | True |
| Cross-Mailbox | False | False | True |
| Search | | | |
| Legal Hold | False | False | True |

For Non-Cmdlet Based ITPro Features the issue is highlighted by the asterisk ‘*’, the feature is enabled or used fully independent of any given user object and is not confined within Cmdlet Execution. Since this is a service runtime rather than a cmdlet based action that needs to be restricted, RBAC may not necessarily be required to come into play in the authorization path.

For example the difference between a Journal Rule applied per Database and a Journal Rule applied per user is the use of the New-JournalRule cmdlet. However, once this cmdlet is granted to an Administrator there is nothing to say that she can't create New-JournalRules that apply to a DeskLess or Standard user. Worse is that she could apply the New-JournalRule to a Distribution Group which could contain Deskless, Standard or Enterprise users at any point in time as Distribution Group membership should be assumed fluid over time. For Cross Mailbox Search and Legal Hold can be fully Cmdlet Execution controlled since the RBAC infrastructure is part of the authorization path for the actions. Cross Mailbox Search can imply that an action that can be performed across multiple mailboxes will be restricted on a per-mailbox basis depending on their assigned capability set.

### Example 4

Ensuring administrators do not violate a license through a Role Assignment using the association between RBAC Roles and Mailbox Plans, as illustrated by the examples in Table 12.

TABLE 12

| Feature | DeskLess | Standard | Enterprise |
|---|---|---|---|
| OWA Inbox Rules | False | True | True |
| OWA SMS Text | False | True | True |
| Messaging control | | | |

In order to ensure that an Administrator who is managing RBAC Role Assignments to the Role Assignment Policy associated with the Deskless worker SKU (set of capabilities) does not inadvertently grant these users the right to use either of these ECP features, ensure that a grant limited to end-user roles that are associated with the Deskless capability set to the Role Assignment Policy that is somehow similarly associated with the Deskless capability set. Other examples and embodiments are available.

In one embodiment, a command-line shell (e.g., WINDOWS POWERSHELL) can include an interactive prompt and a scripting environment, used independently or in combination. For example, the shell can be built on top of a framework common language runtime (CLR) and associated framework (e.g., .NET), including accepting and returning framework objects. In one embodiment, a command-line shell includes a single-function command-line tool, termed a cmdlet as part of the shell. A cmdlet is a lightweight command that is used in the POWERSHELL environment. The POWERSHELL runtime invokes cmdlets within the context of automation scripts that are provided at the command line. The POWERSHELL runtime also invokes them programmatically through APIs.

Cmdlets perform an action and typically return a.NET Framework object to the next command in the pipeline. A cmdlet attribute includes a .NET Framework attribute that is used to declare a cmdlet class as a cmdlet. Cmdlet parameters includes required, named, positional, and switch parameters. Switch parameters allow defining of parameters that are evaluated only if the parameters are specified in a call. A parameter set includes a group of parameters that can be used in the same command to perform a specific action. A cmdlet can have multiple parameter sets, but each parameter set must have at least one parameter that is unique. A dynamic parameter is a parameter that is added to the cmdlet at runtime.

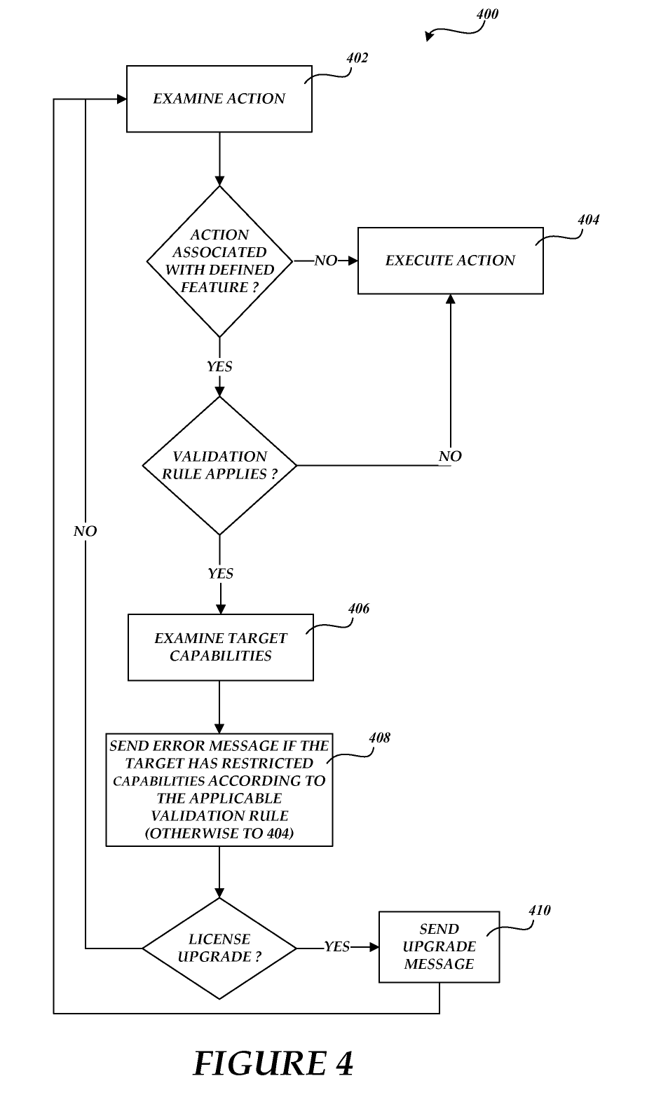

FIG. 4 is a flow diagram illustrating an exemplary process 400 of providing control access features as part of enforcing and monetizing license and other features. At 402, the process 400 examines an action input by a user. For example, an RBAC runtime component can examine a command input and determine if the command input is associated with service features of a subscribed-to service. At 404, if the action is not associated with a defined feature, the action executes. If the action is associated with a defined feature but no validation rules apply, the action executes at 404. If the action is associated with a defined feature and a validation rule applies to the defined feature, at 406, the process 400 operates to examine capabilities and/or restricted capabilities of the target of the action.

At 408, the process 400 of one embodiment operates to send an error message to a command initiator if the target has restricted capabilities according to the applicable validation rule, otherwise the process 400 proceeds to 404. At 410, the process 400 of an embodiment operates to send an upgrade message to a command initiator upon a successful license upgrade, including confirmation of payment or promise of payment and alert that the previously applicable validation rule is no longer applicable; otherwise the process 400 proceeds to 402. While a certain number and order of operations is described for the exemplary flow of FIG. 4, it will be appreciated that other numbers and/or orders can be used according to desired implementations.

While certain embodiments are described herein, other embodiments are available, and the described embodiments should not be used to limit the claims. Exemplary communication environments for the various embodiments can include the use of secure networks, unsecure networks, hybrid networks, and/or some other network or combination of networks. By way of example, and not limitation, the environment can include wired media such as a wired network or direct-wired connection, and/or wireless media such as acoustic, radio frequency (RF), infrared, and/or other wired and/or wireless media and components. In addition to computing systems, devices, etc., various embodiments can be implemented as a computer process (e.g., a method), an article of manufacture, such as a computer program product or computer readable media, computer readable storage medium, and/or as part of various communication architectures.

The term computer readable media as used herein may include computer storage media. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of device. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components include, but are not limited to, wide area networks (WANs), local area networks (LANs), metropolitan area networks (MANs), proprietary networks, backend networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions. Other embodiments and configurations are available.

### Exemplary Operating Environment

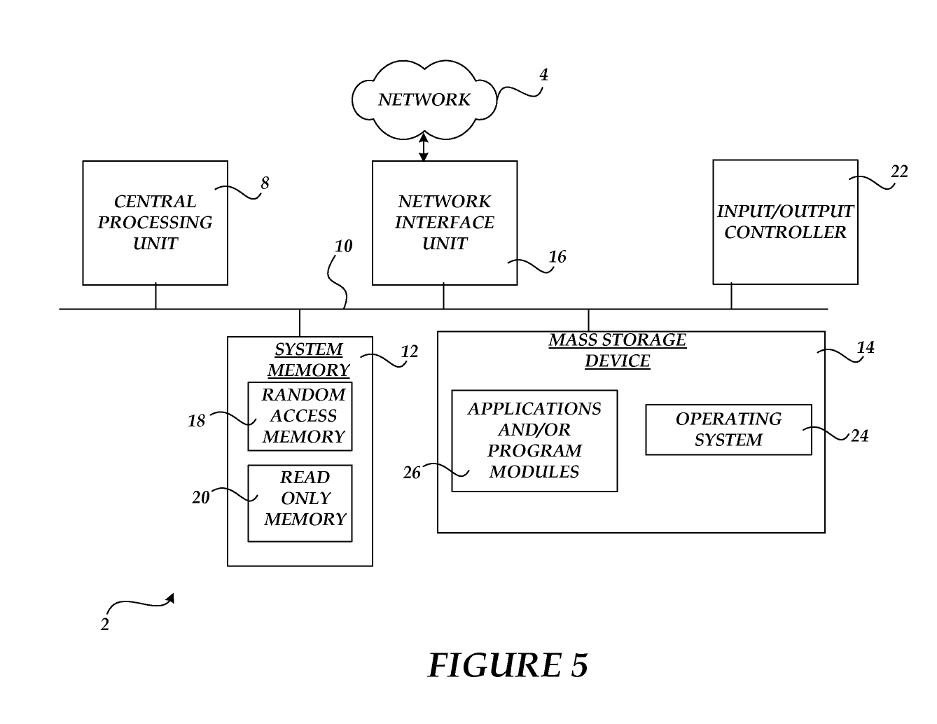

Referring now to FIG. 5, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 5, an illustrative operating environment for embodiments of the invention will be described. As shown in FIG. 5, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules 26.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention.

Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

1. A method comprising:
receiving a command input associated with an action;
using a mapping database to determine if the action is associated with a defined feature;
identifying any validation rules associated with the defined feature;
identifying one or more capabilities associated with a target of the action;
determining if a validation rule applies to the target; and
sending a communication to a command executor when the one or more capabilities of the target violate the validation rule.

2. The method of claim 1, further comprising determining if the action is associated with a mailbox feature and sending an error message to the command executor with information to inform the command executor of a reason for the error message.

3. The method of claim 1, further comprising determining if the defined feature is restricted from users having a set of capabilities that includes a first type of user.

4. The method of claim 1, further comprising determining if the defined feature is associated with an object having a restricted set of capabilities for the feature.

5. The method of claim 1, further comprising examining a scope set and using any applicable validation rules associated with the defined feature.

6. The method of claim 1, wherein the one or more capabilities dictate a unique set of features that a customer can purchase or use.

7. The method of claim 1, wherein validation rules are used in part to control and manage an inadvertent or intentional administrator change, including a change that violates an assigned set of capabilities.

8. The method of claim 1, wherein validation rules are implemented to control and manage an inadvertent or intentional administrator change, including a change that violates a license term.

9. The method of claim 1, further comprising determining if an administrator has been granted rights to perform the action and using a role-based control access (RBAC) runtime to perform a validation evaluation as part of a scope check to ensure that the target of the action is within an administrator scope.

10. The method of claim 1, further comprising identifying any restricted capabilities associated with the target of the action.

11. The method of claim 1, further comprising sending an error message to a command executor upon a validation rule violation including offering a new license for a fee to overcome the error message.

12. The method of claim 1, further comprising sending an error message to an administrator or an end-user when a validation rule is violated.

13. The method of claim 1, further comprising defining a set of capabilities based in part on a subscription type.

14. A system comprising:
a processing unit;
a memory having computer readable instructions, which when executed by the processing unit cause the system to be operable to:
receive a command input associated with an action;
use a mapping database to determine if the action is associated with a defined feature;
identify any validation rules associated with the defined feature;
identify one or more capabilities associated with a target of the action;
identify any restricted capabilities associated with the target of the action;
determine if a validation rule applies to the target; and
send a communication to a command executor when the one or more capabilities of the target violate the validation rule or the restricted capabilities.

15. The system of claim 14, wherein the system is further operable to determine if the action is associated with a mailbox feature and sending an error message to the command executor with information to inform the command executor of a reason for the error message.

16. The system of claim 14, wherein the system is further operable to determine if the defined feature is restricted from users having a set of capabilities that includes a first type of user.

17. The system of claim 14, wherein the system is further operable to determine if the defined feature is associated with an object having a restricted set of capabilities for the feature.

18. The system of claim 14, wherein the system is further operable to examine a scope set and using any applicable validation rules associated with the defined feature.

19. The system of claim 14, wherein the one or more capabilities dictate a unique set of features that a customer can purchase or use.

20. A computer readable storage medium having computer readable instructions, which when executed by a processing unit, perform a method comprising:
receiving a command input associated with an action;
defining a set of capabilities based in part on a subscription type;
using a mapping database to determine if the action is associated with a defined feature;
identifying any validation rules associated with the defined feature;
identifying one or more capabilities associated with a target of the action;
determining if a validation rule applies to the target;
determining if the defined feature is associated with an object having a restricted set of capabilities for the feature; and
sending a communication to a command executor when the one or more capabilities of the target violate the validation rule.
